(19) United States
(12) Patent Application Publication
(10) Pub. No.: US 2026/0188984 A1
(43) Pub. Date: Jul. 2, 2026

(54) SPARK PLUG SYSTEMS AND METHODS

(71) Applicant: INNIO Waukesha Gas Engines Inc., Waukesha, WI (US)

(72) Inventor: Lorne Eugene Nix, Waukesha, WI (US)

(21) Appl. No.: 19/007,312

(22) Filed: Dec. 31, 2024

(51) Int. Cl. H01T 13/39; F02M 57/06; H01T 13/08; H01T 13/32; H01T 21/02

(52) U.S. Cl. CPC H01T 13/39; F02M 57/06; H01T 13/08; H01T 13/32; H01T 21/02

(57) ABSTRACT

A spark plug for a spark ignited reciprocating internal combustion engine includes a mounting portion and an ignition portion. One or more surfaces of the ignition portion are at least partially coated with a thermal barrier coating.

### BACKGROUND

The subject matter disclosed herein relates to reciprocating piston-cylinder engines and, more specifically, to a spark plug.

Spark plugs are used in a variety of spark-ignited reciprocating piston-cylinder engines. Over time, spark plugs degrade at least in part due to the heat absorbed from the combustion that takes place in the combustion chamber of the engine. Accordingly, a need exists for limiting the amount of heat absorbed by the spark plug, thereby extending the life of the spark plug.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the present disclosure. Indeed, the present disclosure may encompass a variety of forms that may be similar to or different from the embodiments set forth below.

In certain embodiments, a spark plug for a spark ignited reciprocating internal combustion engine includes a mounting portion and an ignition portion. One or more surfaces of the ignition portion are at least partially coated with a thermal barrier coating.

In certain embodiments, an apparatus includes an electrode of a spark plug for a spark ignited reciprocating internal combustion engine. One or more surfaces of the electrode are at least partially coated with a thermal barrier coating.

In certain embodiments, a method of manufacturing a spark plug includes roughening a surface of an ignition portion of the spark plug. The method also includes coating the roughened surface with a thermal barrier coating. The method also includes cutting one or more holes in the surface, the roughened surface, or both.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a cross-sectional side view of an embodiment of a reciprocating engine having a spark plug in accordance with aspects of the present disclosure;

FIG. 2 is a perspective view of an embodiment of the spark plug of FIG. 1 in accordance with aspects of the present disclosure;

FIG. 3 is a perspective close-up view of the spark plug of FIG. 2 taken within an area 3-3, illustrating an ignition portion of the spark plug having a thermal barrier coating in accordance with aspects of the present disclosure;

FIG. 4 is a perspective view of an embodiment of an ignition portion of a side gap spark plug having a thermal barrier coating in accordance with aspects of the present disclosure;

FIG. 5 is a perspective view of an embodiment of an ignition portion of a J-gap spark plug having a thermal barrier coating in accordance with aspects of the present disclosure;

FIG. 6 is a perspective view of an embodiment of an ignition portion of a multi-prong spark plug having a thermal barrier coating in accordance with aspects of the present disclosure;

FIG. 7 is a perspective view of an embodiment of an ignition portion of a shielded spark plug having a thermal barrier coating in accordance with aspects of the present disclosure;

FIG. 8 is a side cross-sectional view of the spark plug of FIG. 2 taken along line 8-8, illustrating an ignition portion having a thermal barrier coating and an anti-corrosion coating in accordance with aspects of the present disclosure; and

FIG. 9 is a flowchart of an example process for coating a spark plug with a thermal barrier coating in accordance with aspects of the present disclosure.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments provide systems and methods for coating one or more surfaces of a spark plug with a thermal barrier coating. In particular, the present disclosure provides a spark plug with an ignition portion (e.g., an electrode assembly) having one or more surfaces at least partially coated with the thermal barrier coating. In certain embodiments, the thermal barrier coating includes a polymer ceramic having a thickness of less than or equal to 100 microns and a thermal conductivity of between 0.01 watts per meter-kelvin and 0.1 watts per meter-kelvin. As discussed herein, the spark plug may include a variety of types of spark plugs, including an annular gap spark plug, a side gap spark plug, J-gap spark plug, multi-prong spark plug, and/or a shielded spark plug. The disclosed embodiments also provide for a thermal barrier coating in combination with an anti-corrosion coating. In certain embodiments, the thermal barrier coating and/or the anti-corrosion coating may cover substantially all surfaces exposed to hot combustion gases, except for surface locations directly at the location of a spark path. Additionally, the thermal barrier coating and the anti-corrosion coating may coat spark plugs constructed with a variety of materials, including copper, nickel, nickel alloys, and precious metals (e.g., platinum, iridium, etc.). For example, at the spark path, the electrode surfaces may include nickel, nickel alloy, or a precious metal, whereas all other surfaces of the ignition portion may include the thermal barrier coating and the anti-corrosion coating. The disclosed embodiments also provide for a method of applying the thermal barrier coating to the one or more surfaces of the spark plug.

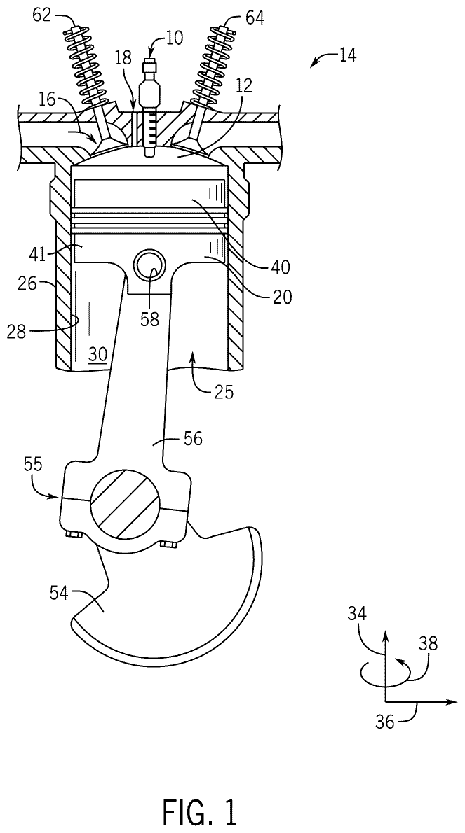

FIG. 1 is a cross-sectional side view of an embodiment of an engine 14 (e.g., reciprocating engine, reciprocating internal combustion engine, etc.) having a spark plug 10 configured to ignite a fuel-air mixture in a combustion chamber 12 within a piston-cylinder assembly 25. As discussed in further detail below, the spark plug 10 may include one or more coatings (e.g., thermal barrier coating and anti-corrosion coating) to protect the spark plug 10 from thermal degradation and corrosion over time. For example, the one or more coatings may be applied to all or part of the surfaces of the spark plug 10, such as all or part of the surfaces of the spark plug 10 exposed to hot combustion gases during operation of the engine 14. In certain embodiments, the one or more coatings may be applied to all or part of an ignition portion of the spark plug 10, while leaving surfaces directly along a spark path uncoated by the one or more coatings. Various aspects of the engine 14 are described below as context for the spark plug.

The engine 14 may include any number of combustion chambers 12 and associated piston-cylinder assemblies 25. Each piston-cylinder assembly 25 includes the combustion chamber 12 adjacent a piston 20 within a cylinder 26. The cylinder 26 has an inner annular wall 28 defining a cylindrical cavity 30 (e.g., cylindrical bore). The operation of the piston-cylinder assembly 25 may be defined by an axial axis or direction 34, a radial axis or direction 36, and a circumferential axis or direction 38. The piston 20 includes an upper or top portion 40 (e.g., a top land or crown portion) having a plurality of rings configured to contain pressure within the combustion chamber 12. The piston 20 also includes a lower, bottom, or body portion 41 coupled to the top portion 40, which is coupled to a crankshaft 54 via a connecting rod 56 and a pin 58. As discussed below, a fuel-air mixture combusts in the combustion chamber 12, thereby driving a reciprocating linear motion of the piston 20 between a top dead center (TDC) position and a bottom dead center (BDC) position in the cylinder 26. As the piston 20 moves from top to bottom or from bottom to top, the crankshaft 54 rotates one half of a revolution. Each movement of the piston 20 from top to bottom or from bottom to top is called a stroke, and the engine 14 embodiments may include two-stroke engines, three-stroke engines, four-stroke engines, five-stroke engine, six-stroke engines, or more. The crankshaft 54 converts the reciprocating linear motion of the piston 20 into a rotating motion to drive a load 55. The load 55 may include an electrical generator, a compressor, a pump, a propulsion system of a vehicle (e.g., a watercraft, an aircraft, or a land vehicle such as a car, a truck, a motorcycle, or a locomotive), or other machinery.

The engine 14 is driven by a spark ignition by the spark plug 10 of an air-fuel mixture in the combustion chamber 12. In operation, an air supply system supplies a pressurized oxidant 16, such as air, oxygen, oxygen-enriched air, oxygen-reduced air, or any combination thereof, to each combustion chamber 12. Additionally, a fuel supply system supplies a fuel 18 (e.g., a liquid and/or gaseous fuel) to each combustion chamber 12. The fuel 18 may be any suitable gaseous fuel, such as natural gas, associated petroleum gas, propane, biogas, sewage gas, landfill gas, and/or coal mine gas, for example. In certain embodiments, the air supply system includes an intake valve 62 configured to control the delivery of oxidant 16 to the combustion chamber 12, while an exhaust system includes an exhaust valve 64 configured to control the discharge of exhaust from the engine 14. In certain embodiments, the fuel 18 is mixed with the oxidant 16 upstream of the intake valve 62 via a mixer, a manifold, or any combination thereof. In some embodiments, the engine 14 includes a direct fuel injection system having a fuel injector coupled to the combustion chamber 12. The spark plug 10 generates a spark to ignite and combust the air-fuel mixture within the combustion chamber 12. The embodiments described in detail below provide various coatings on the spark plug 10 to protect the spark plug from thermal degradation and corrosion over time.

The engine 14 disclosed herein may be adapted for use in large-scale industrial applications. The engine 14 may also include any number of piston-cylinder assemblies 25 and associated combustion chambers 12 (e.g., 1-24). For example, in certain embodiments, the engine 14 may include a large-scale industrial reciprocating engine having 4, 6, 8, 10, 16, 24 or more pistons 20 reciprocating in cylinders 26. In some cases, the cylinders 26 and/or the pistons 20 may have a diameter of between approximately 13.5-34 centimeters (cm). In some embodiments, the cylinders 26 and/or the pistons 20 may have a diameter of between approximately 10-40 cm, 15-25 cm, or about 15 cm. The engine 14 may generate power ranging from 10 kW to 10 MW. In some embodiments, the engine 14 may operate at less than approximately 1800 revolutions per minute (RPM). In some embodiments, the engine 14 may operate at less than approximately 2000 RPM, 1900 RPM, 1700 RPM, 1600 RPM, 1500 RPM, 1400 RPM, 1300 RPM, 1200 RPM, 1000 RPM, 900 RPM, or 750 RPM. In some embodiments, the engine 14 may operate between approximately 750-2000 RPM, 900-1800 RPM, or 1000-1600 RPM. In some embodiments, the engine 14 may operate at approximately 1800 RPM, 1500 RPM, 1200 RPM, 1000 RPM, or 900 RPM. Exemplary engines 12 may include Jenbacher Engines (e.g., Jenbacher Type 2, Type 3, Type 4, Type 6 or J920 FleXtra) or Waukesha Engines (e.g., Waukesha VGF, VHP, APG, 275GL), for example.

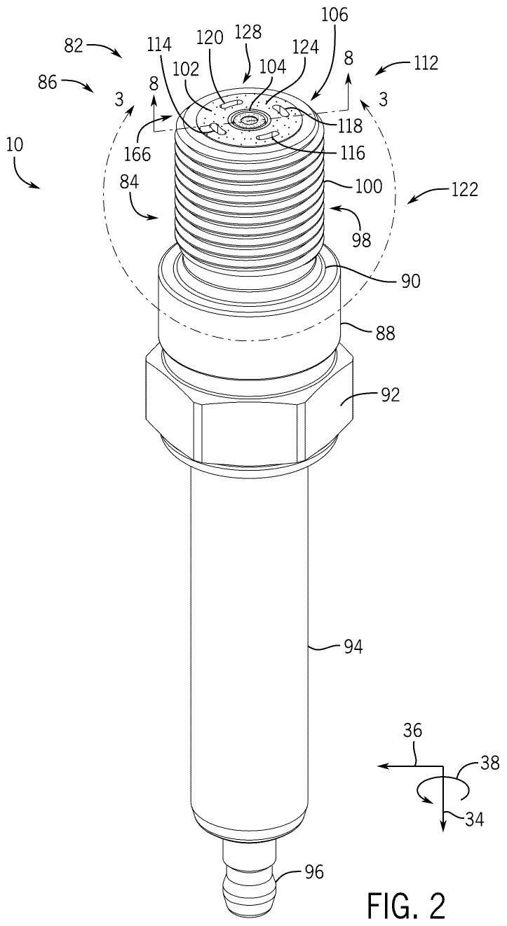

FIG. 2 is a perspective view of the spark plug 10 of the engine 14 of FIG. 1. The spark plug 10 includes a distal end portion 82 having a mounting portion 84 and an ignition portion 86 (e.g., spark ignition tip portion). In addition, the spark plug 10 includes a shell 88, a gasket 90, a tool interface portion 92 (e.g., torque transfer portion, hexagon portion, or hex nut portion), an insulator 94 (e.g., ceramic annular insulator), and a terminal 96. As shown, the mounting portion 84 includes a plurality of threads 98 (e.g., threading) formed into an outer radial surface 100 of the distal end portion 82.

In the illustrated embodiment, the ignition portion 86 includes a ground electrode 102 and a center electrode 104. In the illustrated embodiment, the ground electrode 102 and the center electrode 104 are disposed on an axial end 106 of the ignition portion 86, such that the ground electrode 102 includes a ground electrode surface 103 (e.g., ground electrode distal surface) and the center electrode 104 includes a center electrode surface 105 (e.g., center electrode distal surface). As shown, the ground electrode surface 103 and the center electrode surface 105 are coplanar. As shown, the ground electrode 102 is annular in shape and disposed about the center electrode 104 in a coaxial or concentric arrangement, such that the ground electrode surface 103 is annular and disposed about the center electrode surface 105. The ground electrode surface 103 and the center electrode surface may be oriented toward the piston crown when the spark plug 10 is engaged with the combustion chamber. In certain embodiments, the ground electrode surface 103 and the center electrode surface 105 may occupy a region less than 5 millimeters from an end 107 of the mounting portion 84 (e.g., plurality of threads 98). In the illustrated embodiment, the ground electrode 102 includes a plurality of holes 112 (e.g., holes 114, 116, 118, and 120) formed through the ground electrode 102 and circumferentially disposed about the center electrode 104. It may be appreciated that the coplanar arrangement of the ground electrode surface 103 and the center electrode surface 105 may minimize an area for heat transfer from the engine to the spark plug 10.

Additionally, as discussed in further detail herein, at least a portion of one or more surfaces 122 of the ignition portion 86 are coated with a thermal barrier coating 124 (e.g., thermal barrier layer). In the illustrated embodiment, the one or more surfaces 122 includes one or more surfaces 126 (e.g., one or more first surfaces) of the ground electrode 102 and one or more surfaces 128 (e.g., one or more second surfaces) of the center electrode 104. In certain embodiments, the one or more surfaces 122 may include the one or more surfaces 126, the one or more surfaces 128, or a combination thereof. In certain embodiments, the one or more surfaces 126 may include one or more axial surfaces of the ground electrode 102. Additionally or alternatively, in certain embodiments, the one or more surfaces 128 may include one or more axial surfaces of the center electrode 104.

In certain embodiments, the thermal barrier coating 124 may cover substantially all surfaces exposed to hot combustion gases, except for surface locations directly at the location of a spark path. Additionally, the thermal barrier coating 124 may coat spark plugs 10 constructed with a variety of materials, including precious metals (e.g., iridium, platinum, palladium, ruthenium, rhodium, silver, etc.) and/or non-precious metals (e.g., copper, nickel, nickel alloys, chromium, iron, zinc tin, aluminum, etc.). For example, the surfaces 122 (e.g., 126 and 128) of the ignition portion 86 being coated by the thermal barrier coating 124 may include precious metals (e.g., iridium, platinum, palladium, ruthenium, rhodium, silver, etc.) and/or non-precious metals (e.g., copper, nickel, nickel alloys, chromium, iron, zinc tin, aluminum, etc.). It may be appreciated that the thermal barrier coating 124 may delay the transition between spark plugs 10 composed of non-precious metals and spark plugs 10 composed of precious metals based on the application of power over time. Additionally, it may be appreciated that the thermal barrier coating 124 may enable the spark plug 10 to be composed of a cheaper material.

In certain embodiments, the thermal barrier coating 124 includes a polymer ceramic (e.g., thin-film polymer ceramic), such as polymer derived ceramics (PDCs). PDCs may be formed by the pyrolysis of preceramic polymers, such as in an inert atmosphere. The preceramic polymers may include polysiloxanes, such as poly(organo)siloxanes having polysiloxanes with organic groups in the backbones (e.g., polyborosiloxanes, poly(carbosiloxanes)). The preceramic polymers may include polycarbosilanes and poly(organo)carbosilanes having alternating carbon and silicone atoms in the backbones. The preceramic polymers may include polymers having Si—N bonds, such as polysilazane, poly(organosilazanes), and poly(organosilylcarbodiimides). In certain embodiments, the PDCs may include silicon carbide (SiC), silicon oxycarbide (SiO_{X}C_{Y}), silicon nitride (Si₃N₄), silicon carbonitride (Si_{3+X}N₄C_{X+Y}), and silicon oxynitride (SiO_{X}N_{Y}). In certain embodiments, the polymer ceramic may include polysilazane (PSZ), polycarbosilane (PCS), polyborosilazane, polymer-derived silicone oxycarbide, poly-derived silicone nitride, or a combination thereof. Additionally or alternatively, in certain embodiments, the thermal barrier coating 124 may include one or more additives, one or more porosity modifications, or a combination thereof. The thermal barrier coating 124 may be applied by a variety of coating techniques, including thermal spraying. Additionally or alternatively, in certain embodiments, a thermal conductivity of the thermal barrier coating 124 may be between 0.01 watts per meter-kelvin and 0.1 watts per meter-kelvin. In certain embodiments, the thermal conductivity of the thermal barrier coating 124 may be less than or equal to 0.01, 0.02, 0.03, 0.04, 0.05, 0.06, 0.07, 0.08, 0.09, or 0.1 watts per meter-kelvin.

In certain embodiments, the thermal barrier coating 124 includes a single layer or a plurality of layers. For example, the thermal barrier coating 124 may include a metallic bond layer, a thermally-grown oxide layer, and a ceramic top layer. For example, the metallic bond layer may include oxidation-resistant metallic layer or aluminum-containing alloy, such as an NiCrAlY or an NiCoCrAlY alloy, Ni and Pt aluminides, or any combination thereof. The thermally-grown oxide layer may include Al2O3. The ceramic top coating may include a yttria-stabilized zirconia (YSZ), alumina (Al2O3), a compound of alumina and silica (e.g., mullite, 3Al₂O₃-2SiO₂), a combination of ceria (e.g., CeO₂) and YSZ, rare-earth zirconates (e.g., La₂Zr₂O₇), rare-earth oxides (e.g., La₂O₃, Nb₂O₅, Pr₂O₃, CeO₂), metal-glass composites, or any combination thereof.

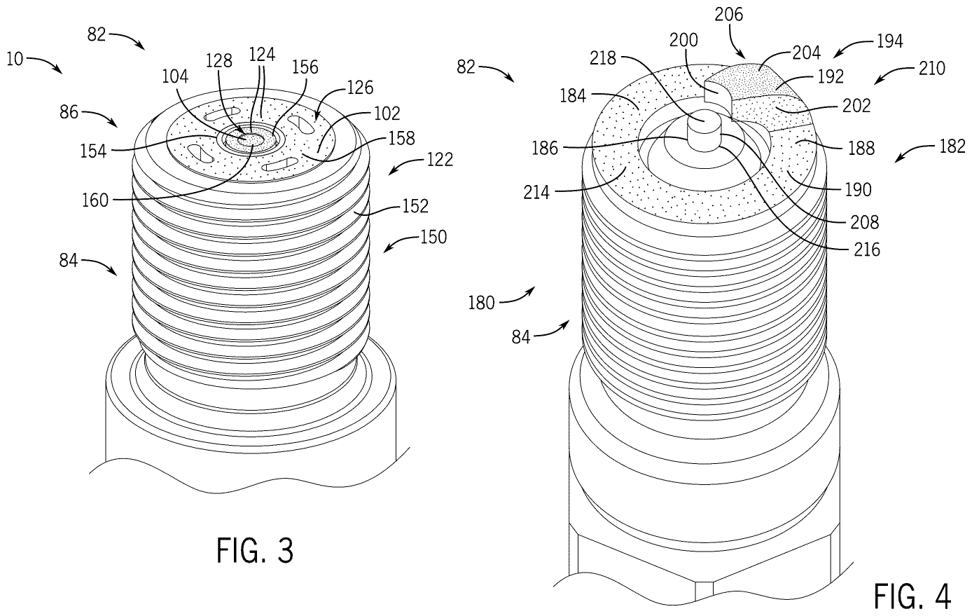

FIG. 3 is a perspective close-up view of the spark plug 10 of FIG. 2 taken within area 3-3, illustrating the distal end portion 82 including the mounting portion 84 and the ignition portion 86 having the thermal barrier coating 124. In the illustrated embodiment, at least a portion of one or more surfaces 122 of the ignition portion 86 are coated with a thermal barrier coating 124 (e.g., thermal barrier layer). In the illustrated embodiment, the one or more surfaces 122 include one or more surfaces 126 (e.g., one or more first surfaces) of the ground electrode 102 and one or more surfaces 128 (e.g., one or more second surfaces) of the center electrode 104. In certain embodiments, the one or more surfaces 122 may include the one or more surfaces 126, the one or more surfaces 128, or a combination thereof. In the illustrated embodiment, the one or more surfaces 126 include one or more axial surfaces of the ground electrode 102, and the one or more surfaces 128 includes one or more axial surfaces of the center electrode 104. As shown, the one or more surfaces 122 does not include a radial surface 150 (e.g., outer radial surface 152, inner radial surface 154) of the ground electrode 102. Additionally or alternatively, the one or more surfaces 122 does not include a radial surface 156 of the center electrode 104. Thus, the thermal barrier coating 124 is not disposed on the radial surfaces 150 and 156 directly along a spark path or spark gap.

As shown, the thermal barrier coating 124 includes a ground electrode coating 158 and a center electrode coating 160. In certain embodiments, a composition, a thickness, a number of layers, or any combination thereof, of the ground electrode coating 158 and the center electrode coating 160 is the same. In certain embodiments, a composition, a thickness, a number of layers, or any combination thereof, of the ground electrode coating 158 is different than the center electrode coating 160. For example, the ground electrode coating 158 may be composed of PSZ and the center electrode coating 160 may be composed of PCS. In certain embodiments, the ground electrode coating 158, the center electrode coating 160, or a combination thereof may be omitted. In certain embodiments, the one or more surfaces 122 may selectively coated (e.g., masked) such that unintended overspray of the thermal barrier material does not occur on specified surfaces of the one or more surfaces 122.

FIG. 4 is a perspective view of an embodiment of the spark plug 10 of FIG, 2, illustrating an ignition portion 180 of a side gap spark plug 182 having a thermal barrier coating 184. In the illustrated embodiment, the side gap spark plug 182 includes a center electrode 186 and a ground electrode 188. As shown, the ground electrode 188 includes an annular portion 190 and a protrusion 192 that extends radially inward from the annular portion 190 toward the center electrode 196.

As shown, the protrusion 192 includes surfaces 194 (e.g., surfaces 200, 202, 204, and 206). As shown, the radially inward surface 200 is disposed radially outward from the center electrode 186. The protrusion 192 does not cross an outer perimeter 208 of the center electrode 186. That is, the protrusion 192 is disposed adjacent to (e.g., to the side of) the center electrode 186.

In the illustrated embodiment, the ignition portion 180 includes one or more surfaces 210 that are at least partially coated with the thermal barrier coating 184. In certain embodiments, the one or more surfaces 210 may include the surfaces 202, 204, 206, an axial surface 214 of the annular portion 190 of the ground electrode 188, or a combination thereof. The one or more surfaces 210 may not include the radially inward surface 200 of the protrusion 192, a radially outward surface 216 of the center electrode 186, an axial surface 218 of the center electrode 186, or a combination thereof.

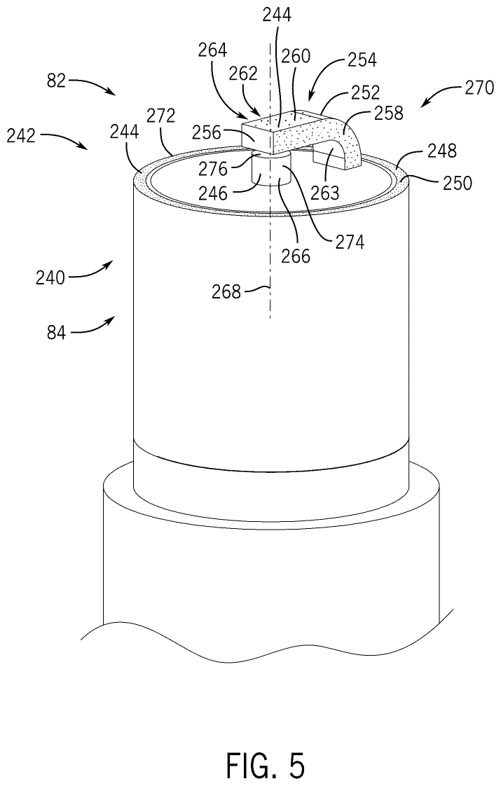

FIG. 5 is a perspective view of an embodiment of the spark plug 10 of FIG. 2, illustrating an ignition portion 240 of a J-gap spark plug 242 having a thermal barrier coating 244. In the illustrated embodiment, the J-gap spark plug 242 includes a center electrode 246 and a ground electrode 248. As shown, the ground electrode 248 includes an annular portion 250 and a protrusion 252 that extends radially inward from the annular portion 250 toward the center electrode 246.

As shown, the protrusion 252 includes surfaces 254 (e.g., surfaces 256, 258, 260, 262, and 263). A distal end portion 264 of the protrusion 252 is disposed above the center electrode 246, such that the distal end portion 264 overlaps an outer perimeter 266 of the center electrode 246. As shown, the distal end portion 264 intersects a central axis 268 of the center electrode 246.

In the illustrated embodiment, the ignition portion 240 includes one or more surfaces 270 that are at least partially coated with the thermal barrier coating 244. In certain embodiments, the one or more surfaces 270 may include the surfaces 258, 260, 260, an axial surface 272 of the annular portion 250 of the ground electrode 248, or a combination thereof. The one or more surfaces 270 may not include the surface 256 (e.g., side surface) of the protrusion 192, the surface 263 (e.g., bottom surface) of the protrusion 192, a radially outward surface 274 of the center electrode 186, an axial surface 276 of the center electrode 186, or a combination thereof.

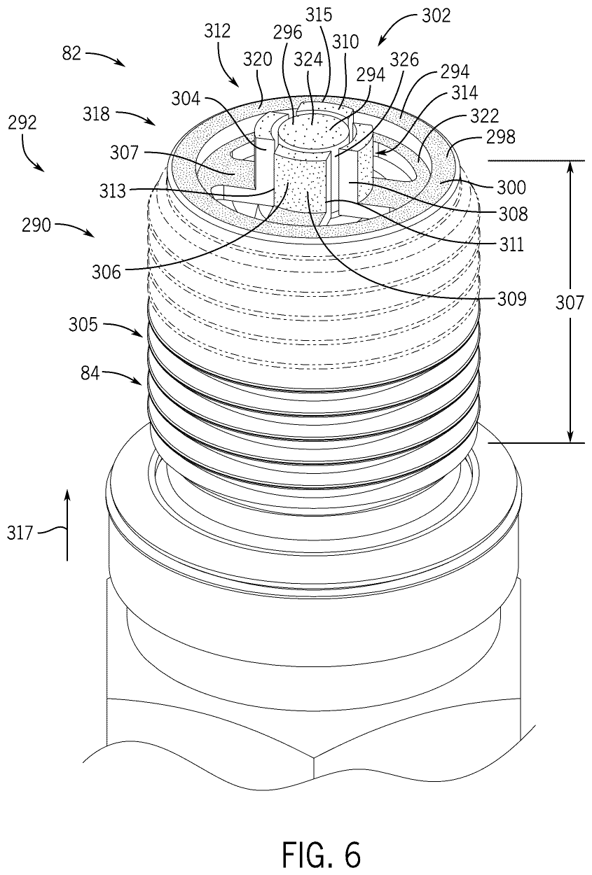

FIG. 6 is a perspective view of an embodiment of the spark plug 10 of FIG. 2, illustrating an ignition portion 290 of a multi-prong spark plug 292 having a thermal barrier coating 294. In the illustrated embodiment, the multi-prong spark plug 292 includes a center electrode 296 and a ground electrode 298. As shown, the ground electrode 298 includes an annular portion 300 and a plurality of protrusions 302 (e.g., protrusions 304, 306, 308, 310) that extend radially inward from the annular portion 300 toward the center electrode 296. In the illustrated embodiment, the multi-prong spark plug 292 includes four protrusions 302 (e.g., prongs). In certain embodiments, the multi-prong spark plug 292 may include fewer or more than four protrusions 302. For example, the multi-prong spark plug 292 may include 1, 2, 3, 5, 6, or more protrusions 302. In certain embodiments, an outer radial surface 303 of the ground electrode 298 may include a plurality of threads 305 that span at least a portion of a height dimension 307 of the ignition portion 290.

As shown, each of the protrusions 302 includes surfaces 304 (e.g., surfaces 306, 308, 310, 312, and 313). As shown, each protrusion 302 includes a vertical portion 314 that extends upward in the direction 317 and is disposed outward of an outer radial surface 316 of the center electrode 296. As shown, each of the protrusions 302 is circumferentially curved about the center electrode 296.

In the illustrated embodiment, the ignition portion 290 includes one or more surfaces 318 that are at least partially coated with the thermal barrier coating 294. In certain embodiments, the one or more surfaces 318 may include the surfaces 306 and 308, axial surfaces 320 and 322 of the annular portion 300 of the ground electrode 298, an axial surface 324 of the center electrode 296, or a combination thereof. The one or more surfaces 318 may not include the surfaces 310 and 312 (e.g., side surfaces) of each of the protrusions 302, the surface 313 (e.g., inner radial surface) of each protrusion 302, a radially outward surface 326 of the center electrode 296, or a combination thereof.

FIG. 7 is a perspective view of an embodiment of the spark plug 10 of FIG. 2, illustrating an ignition portion 350 of a shielded spark plug 352 having a thermal barrier coating 354. In the illustrated embodiment, the shielded spark plug 352 includes a center electrode 356 and a ground electrode 358. As shown, the ground electrode 358 includes an annular portion 360 (e.g., annular shield, perforated annular wall) and a plurality of protrusions 362 (e.g., protrusions 364, 366, 368, 370) that extend radially inward from an inner radial surface 372 of the annular portion 360 toward the center electrode 356. In the illustrated embodiment, the multi-prong spark plug 292 includes four protrusions 362. In certain embodiments, the shielded spark plug 352 may include fewer or more than four protrusions 362. For example, the pronged spark plug 352 may include 1, 2, 3, 5, 6, or more protrusions 362. In the illustrated embodiment, the annular portion 360 (e.g., shield) of the ground electrode 358 includes a plurality of U-shaped holes 374 and a plurality of holes 376 formed through the annular portion 360. It may be appreciated that the annular portion 360 may modify the charge velocity flow field between the center electrode 356 and the ground electrode 358 to facilitate a healthy and controlled spark. As shown, each of the protrusions 362 includes surfaces 378 (e.g., surfaces 380, 382, 384, and 386). Each protrusion 362 extends radially inward from the ground electrode 358 toward the center electrode 356.

In the illustrated embodiment, the ignition portion 350 includes one or more surfaces 388 that are at least partially coated with the thermal barrier coating 354. In certain embodiments, the one or more surfaces 388 may include the surface 380 (e.g., top surface) of each protrusion 362, an axial surface 390 of the center electrode 356, an axial surface 391 of the ground electrode 358, an outer radial 393 surface of the ground electrode 358, or a combination thereof. The one or more surfaces 388 may not include the surfaces 384 and 386 (e.g., side surfaces) of each of the protrusions 362, the surface 382 (e.g., inner radial surface) of each protrusion 362, a radially outward surface 392 of the center electrode 356, or a combination thereof. It may be appreciated that the thermal barrier coating 354 may expand the shielded spark plug 352 to other applications that were previously not possible due to heat loading limitations.

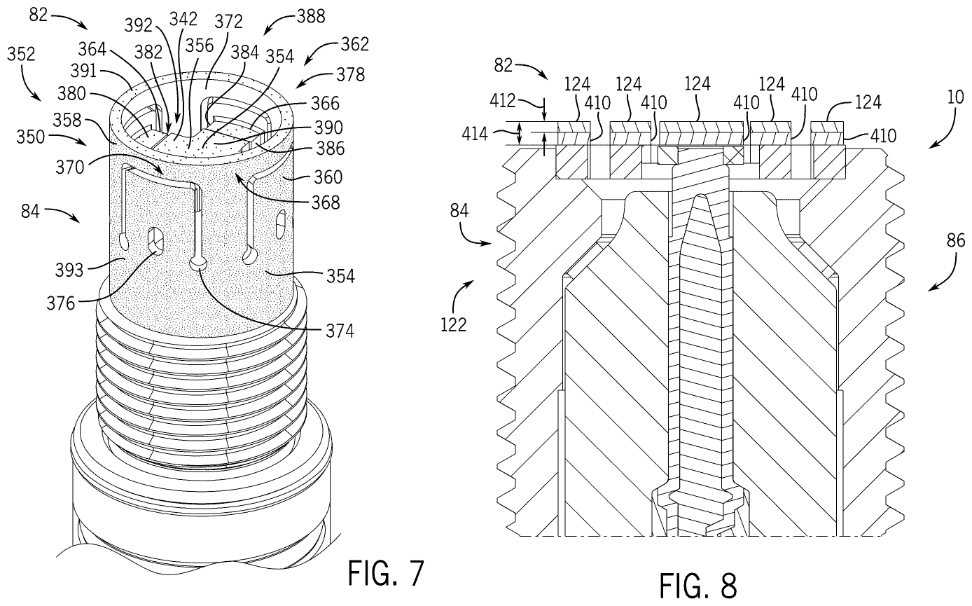

FIG. 8 is a side cross-sectional view of the spark plug 10 of FIG. 2 taken along line 8-8, illustrating details of the ignition portion 86 of the spark plug 10 having the thermal barrier coating 124 and an anti-corrosion coating 410. In the illustrated embodiment, at least one of the surfaces 122 of the ignition portion 86 is coated with the thermal barrier coating 124 and/or the anti-corrosion coating 410. In the illustrated embodiments, the thermal barrier coating 124 is disposed above (e.g., layered on top of) the anti-corrosion coating 410. In certain embodiments, the anti-corrosion coating 410 may be disposed above the thermal barrier coating 124. In certain embodiments, a thickness 412 of the thermal barrier coating 124 is less than 100 microns. In certain embodiments, the thickness 412 of the thermal barrier coating 124 is between 2 microns and 70 microns, 6 microns and 60 microns, or 10 microns and 50 microns. In certain embodiments, the anti-corrosion coating 410 has a thickness 414 that is equivalent to the thickness 412 of the thermal barrier coating 124. In certain embodiments, the anti-corrosion coating 410 may be omitted.

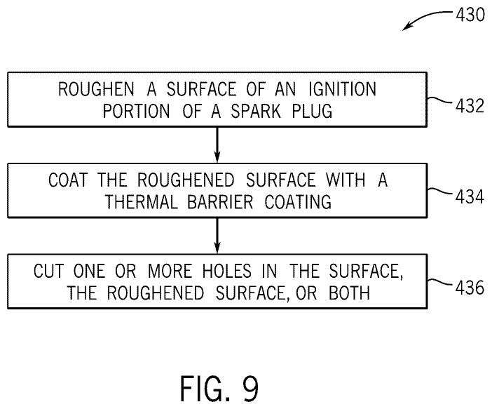

FIG. 9 is a flowchart of an example process 430 for coating the spark plug 10 with a thermal barrier coating 124. The blocks of the process 430 may be performed in the order disclosed herein or in any other suitable order. For example, certain blocks of the process 430 may be performed concurrently. In addition, in certain embodiments, at least one of the blocks of the process 430 may be omitted. In certain embodiments, the process 430 may include a computer-implemented process to control equipment to apply the thermal barrier coating 124, such as control via one or more controllers of a roughening machine, a coating machine, and a cutting machine.

In block 432 of the process 430, the one or more surfaces 122 (e.g., and/or the one or more surfaces 210, 270, 318, 388) of the ignition portion 86 (e.g., and/or the ignition portions 180, 240, 290, 350) of the spark plug 10 (e.g., and/or the side gap spark plug 182, J-gap spark plug 242, multi-prong spark plug 292, shielded spark plug 352) are roughened. For example, the one or more surfaces 122 may be shot peened and/or sandblasted by the roughening machine to prepare the one or more surfaces 122 for coating.

In block 434 of the process 430, the one or more surfaces 122 are coated with the thermal barrier coating 124 via control of the coating machine. As discussed herein, in certain embodiments, the thermal barrier coating 124 may include a polymer ceramic (e.g., thin-film polymer ceramic). In certain embodiments, the polymer ceramic may include polysilazane (PSZ), polycarbosilane (PCS), polyborosilazane, polymer-derived silicone oxycarbide, poly-derived silicone nitride, or a combination thereof. In certain embodiments, the coating machine may include a thermal spraying machine. In certain embodiments, at least one surface of the one or more surfaces 122 may be at least partially masked (e.g., covered) to prevent unintended overspray of the coating onto unwanted surfaces. For example, surfaces directly at the spark path may be masked to avoid coverage by the thermal barrier coating 124.

In block 436 of the process 430, one or more holes 112 are cut into the one or more surfaces 122 via the cutting machine. The one or more holes 112 may be cut prior to or after coating the one or more surfaces 122 with the thermal barrier coating 124. In certain embodiments, the one or more holes 112 are cut into the ground electrode 102, the center electrode 104, or a combination thereof. In certain embodiments, the one or more holes 112 may be omitted.

Technical effects of the disclosed embodiments include thermal protection of one or more surfaces of a spark plug to prolong a life of the spark plug. For example, one or more layers of a thermal barrier coating are applied to a distal end portion of the spark plug, such as along surfaces of an ignition portion of the spark plug. The thermal barrier coating may substantially completely cover surfaces of the ignition portion of the spark plug, except for surfaces directly in the spark path for spark ignition. The thermal barrier coating may be applied to any type of spark plug, and any grade of spark plug using cheaper materials (e.g., nickel alloys) or more expensive materials (e.g., precious metals). The thermal barrier coating may be applied before and/or after assembly of the spark plug. For example, one or more components of the spark plug may be coated with the thermal barrier coating prior to assembly of the spark plug, such as portions of the ignition portion (e.g., surfaces of electrodes).

The subject matter described in detail above may be defined by one or more clauses, as set forth below.

According to a first aspect, a spark plug for a spark ignited reciprocating internal combustion engine includes a mounting portion and an ignition portion. One or more surfaces of the ignition portion are at least partially coated with a thermal barrier coating.

The spark plug of the preceding clause, wherein the ignition portion includes a ground electrode, a center electrode, or both, wherein the one or more surfaces includes one or more first surfaces of the ground electrode, one or more second surfaces of the center electrode, or both.

The spark plug of any preceding clause, wherein the one or more first surfaces includes one or more axial surfaces of the ground electrode, the one or more second surfaces includes one or more axial surfaces of the center electrode, or both.

The spark plug of any preceding clause, wherein the one or more surfaces do not include a radial surface of the ground electrode, a radial surface of the center electrode, or both.

The spark plug of any preceding clause, wherein the one or more surfaces are at least partially coated with an anti-corrosion coating, the thermal barrier coating, or a combination thereof.

The spark plug of any preceding clause, wherein the thermal barrier coating is disposed on top of the anti-corrosion coating.

The spark plug of any preceding clause, wherein a thickness of the thermal barrier coating is between 10 and 50 microns.

The spark plug of any preceding clause, wherein the thermal barrier coating includes a thin-film polymer ceramic.

The spark plug of any preceding clause, wherein the thin-film polymer ceramic includes polysilazane (PSZ), polycarbosilane (PCS), polyborosilazane, polymer-derived silicone oxycarbide, poly-derived silicone nitride, or a combination thereof.

The spark plug of any preceding clause, wherein the thermal barrier coating includes one or more additives, one or more porosity modifications, or a combination thereof.

The spark plug of any preceding clause, wherein a thermal conductivity of the thermal barrier coating is between 0.01 watts per meter-kelvin and 0.1 watts per meter-kelvin.

The spark plug of any preceding clause, wherein the ignition portion is configured to face a combustion chamber of the spark ignited reciprocating internal combustion engine.

According to a second aspect, an apparatus includes an electrode of a spark plug for a spark ignited reciprocating internal combustion engine. One or more surfaces of the electrode are at least partially coated with a thermal barrier coating.

The apparatus of the preceding clause, wherein the electrode includes a ground electrode, a center electrode, or both.

The apparatus of any preceding clause, wherein the one or more surfaces includes one or more axial surfaces of the ground electrode, an axial surface of the center electrode, or both.

The apparatus of any preceding clause, wherein the one or more surfaces does not include a radial surface of the ground electrode, a radial surface of the center electrode, or both.

The apparatus of any preceding clause, wherein the thermal barrier coating includes a thin-film polymer ceramic.

The apparatus of any preceding clause, wherein the polymer ceramic includes polysilazane (PSZ), polycarbosilane (PCS), polyborosilazane, polymer-derived silicone oxycarbide, poly-derived silicone nitride, or a combination thereof.

The electrode of any preceding clause, wherein a thermal conductivity of the thermal barrier coating is between 0.01 watts per meter-kelvin and 0.1 watts per meter-kelvin.

According to a third aspect, a method of manufacturing a spark plug includes roughening a surface of an ignition portion of the spark plug. The method also includes coating the roughened surface with a thermal barrier coating. The method also includes cutting one or more holes in the surface, the roughened surface, or both.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A spark plug for a spark ignited reciprocating internal combustion engine, comprising:
a mounting portion; and
an ignition portion, wherein one or more surfaces of the ignition portion are at least partially coated with a thermal barrier coating.

2. The spark plug of claim 1, wherein the ignition portion comprises a ground electrode, a center electrode, or both, wherein the one or more surfaces comprises one or more first surfaces of the ground electrode, one or more second surfaces of the center electrode, or both.

3. The spark plug of claim 2, wherein the one or more first surfaces comprises one or more axial surfaces of the ground electrode, the one or more second surfaces comprises one or more axial surfaces of the center electrode, or both.

4. The spark plug of claim 2, wherein the one or more surfaces do not comprise a radial surface of the ground electrode, a radial surface of the center electrode, or both.

5. The spark plug of claim 2, wherein the one or more surfaces are at least partially coated with an anti-corrosion coating, the thermal barrier coating, or a combination thereof.

6. The spark plug of claim 5, wherein the thermal barrier coating is disposed on top of the anti-corrosion coating.

7. The spark plug of claim 2, wherein a thickness of the thermal barrier coating is between 10 and 50 microns.

8. The spark plug of claim 2, wherein the thermal barrier coating comprises a thin-film polymer ceramic.

9. The spark plug of claim 8, wherein the thin-film polymer ceramic comprises polysilazane (PSZ), polycarbosilane (PCS), polyborosilazane, polymer-derived silicone oxycarbide, poly-derived silicone nitride, or a combination thereof.

10. The spark plug of claim 9, wherein the thermal barrier coating comprises one or more additives, one or more porosity modifications, or a combination thereof.

11. The spark plug of claim 1, wherein a thermal conductivity of the thermal barrier coating is between 0.01 watts per meter-kelvin and 0.1 watts per meter-kelvin.

12. The spark plug of claim 1, wherein the one or more surfaces of the ignition portion are combustion chamber facing surfaces configured to face a combustion chamber of the spark ignited reciprocating internal combustion engine.

13. An apparatus, comprising:
an electrode of a spark plug for a spark ignited reciprocating internal combustion engine, wherein one or more surfaces of the electrode are at least partially coated with a thermal barrier coating.

14. The apparatus of claim 13, wherein the electrode comprises a ground electrode, a center electrode, or both.

15. The apparatus of claim 14, wherein the one or more surfaces comprises one or more axial surfaces of the ground electrode, an axial surface of the center electrode, or both.

16. The apparatus of claim 14, wherein the one or more surfaces do not comprise a radial surface of the ground electrode, a radial surface of the center electrode, or both.

17. The apparatus of claim 14, wherein the thermal barrier coating comprises a thin-film polymer ceramic.

18. The apparatus of claim 17, wherein the polymer ceramic comprises polysilazane (PSZ), polycarbosilane (PCS), polyborosilazane, polymer-derived silicone oxycarbide, poly-derived silicone nitride, or a combination thereof.

19. The apparatus of claim 13, wherein a thermal conductivity of the thermal barrier coating is between 0.01 watts per meter-kelvin and 0.1 watts per meter-kelvin.

20. A method of manufacturing a spark plug, comprising:
roughening a surface of an ignition portion of the spark plug;
coating the roughened surface with a thermal barrier coating; and
cutting one or more holes in the surface, the roughened surface, or both.
